(19) United States
(12) Patent Application Publication
(10) Pub. No.: US 2011/0208591 A1
(43) Pub. Date: Aug. 25, 2011

(54) Forecasting Online Advertising Inventory of Day Parting Queries

(76) Inventors: Datong Chen, Santa Clara, CA (US); Erik Vee, San Mateo, CA (US); Jayanth Anandaram, San Francisco, CA (US); Jayavel Shanmugasundaram, Santa Clara, CA (US); Peiji Chen, Saratoga, CA (US)

(21) Appl. No.: 12/711,668

(22) Filed: Feb. 24, 2010

(51) Int. Cl. G06Q 30/00; G06Q 10/00

(52) U.S. Cl. 705/14.61

(57) ABSTRACT

Disclosed is a system to forecast a supply of online advertising demand contracts having day parting targets. The system may receive an online advertising demand contract having a flight duration and a day parting target. The received online advertising demand contract may be processed by converting the day parting target into an hour-of-week day parting target vector. If a first day of the flight duration would generate a conflict in view of the hour-of-week day parting target vector, then the system may generate a new first day contract for the first day of the flight duration.

### BACKGROUND

1. Field

The information disclosed relates to online advertising. More particularly, the information disclosed relates to forecasting a supply of online advertising inventory of day parting queries.

2. Background Information

Online advertising is a form of promotion that uses the Internet and World Wide Web to deliver marketing messages on webpages to attract customers. The marketing of products and services online over the Internet through advertisements is big business. In February 2008, the IAB Internet Advertising Revenue Report conducted by PricewaterhouseCoopers announced that PricewaterhouseCoopers anticipated the Internet advertising revenues for 2007 to exceed US$21 billion. With 2007 revenues increasing 25 percent over the previous 2006 revenue record of nearly US$16.9 billion, Internet advertising presently is experiencing unabated growth.

Online advertising requires the advertiser to select a target audience using target categories such as keywords, channel of interest, locations, and day parting target. Day parting is the practice of dividing the day into several parts, during each of which an advertising system may air a different type of advertising content suitable for that time. Day parting targets allow an advertiser to target specific hours in a week. For example, the eligible impressions can be constrained from 9 AM to 5 PM on Monday to Friday but only 11 AM to 2 PM on Saturday and Sunday. Alternatively, a restaurant may desire to advertise their breakfast menu on a webpage from 7 AM to 10 AM and then advertise their lunch menu until 3 PM, after which they may desire to promote their dinner menu. A retail business may focus on women's products before 4 PM and promote products for teenagers and men from 4 PM to closing hours.

In general, advertisers most often gear advertising content towards a particular demographic. Once they determine their target demographic target, the advertiser then gears their advertising content towards what the target audience typically engages in at that time. A purpose of day parting is to maximize exposure to an online target audience who may be viewing the display screen at different times of the day. However, day parting raises efficiency and conflict issues that need to be addressed.

### SUMMARY

Disclosed is a system to forecast a supply of online advertising demand contracts having day parting targets. The system may receive an online advertising demand contract having a flight duration and a day parting target. The received online advertising demand contract may be processed by converting the day parting target into an hour-of-week day parting target vector. If a first day of the flight duration would generate a conflict in view of the hour-of-week day parting target vector, then the system may generate a new first day contract for the first day of the flight duration.

### BRIEF DESCRIPTION OF THE FIGURES

FIG. 1 illustrates a table 100 containing an example hour-of-week (HOW) bit vector.

FIG. 2 is a block diagram illustrating a system 200.

FIG. 3 is a flow diagram illustrating a method 300 implemented in a computer to forecast a supply of online advertising demand contracts having day parting targets.

FIG. 4 illustrates an example advertising contract 400 having a Jul. 1, 2009 10 AM-Jul. 31, 2009 4 PM flight duration.

FIG. 5 illustrates an example advertising contract 500 having a Jul. 1, 2009 8 AM-Jul. 31, 2009 4 PM flight duration with a 9 AM-5 PM HOW day parting target.

FIG. 6 is a method 600 to determine whether a flight duration of an advertising contract would generate a conflict.

FIG. 7 illustrates a table 700 containing an example 9 AM-5 PM hour-of-week (HOW) bit vector.

FIG. 8 illustrates a table 800 containing an example 0 AM-12 PM hour-of-week (HOW) bit vector.

FIG. 9 illustrates a table 900 containing an example 0 AM-12 PM hour-of-week (HOW) bit vector for each day of the week except Wednesday, which is coded for 9 AM-12 PM HOW.

FIG. 10 is a method 1000 to create a new contract from a conflict contract.

FIG. 11 is a diagrammatic representation of a network 1100.

### DETAILED DESCRIPTION

A webpage may include multiple advertising impression locations into which an ad server may deliver advertisements as a function of supply and demand. Collectively, these advertising impressions make up a supply of advertising inventory. An advertising system may have demand obligations to serve a number of advertisements to this advertising inventory supply over a given amount of time. For example, company A may have a contract with the operators of the advertising system that obligates the operators to deliver 100,000 of company A's advertisements to the supply over a seven day period starting on Monday 8 AM and ending Monday 8 AM.

The operators of the advertising system may have numerous advertising contracts with numerous product sellers and be in possession of numerous page impressions ready to receive advertisements. Each aspect of this supply/demand system may have its own requirements, the collective of which creates a very complex supply and demand relationship. A network entity running the advertising system will work within this complex relationship to find all impressions in the supply matching the target predicate of a contract. One target predicate often utilized by advertisers is day parting.

Day parting is the practice of dividing the day into several parts, during each of which an advertising system may air a different type of advertising content suitable for that time. Day parting targets allow an advertiser to target specific hours in a week. For example, an advertiser may limit the eligibility of impressions to those available 9 AM to 5 PM on Monday to Friday but only 11 AM to 2 PM on Saturday and Sunday.

While day parting provides significant benefits to advertisers, conflicts arise between day parting and demand contract duration. For example, if the network entity running the advertising system bases its day parting system from midnight to midnight, a conflict may arise between day parting and demand contract duration when the flight duration of a demand contract does not extend from midnight to midnight. In resolving this conflict issue, it is important to resolve this conflict issue utilizing an efficient approach to match day parting targets in a supply model.

Impression supply in an online advertising system typically includes a large set of impressions. A key processes in forecasting is to find all impressions in the supply that match the target predicate of a contract. To support day parting target in a contract, the below techniques utilize an hour-of-week (HOW) vector that advertisers may utilize to specify targeting hours in a week. In particular, each HOW vector is a 168-dimensional bit vector, in which each bit indicates one hour in a 168-hour week. In general, information about each impression and each query of day parting target and duration is converted into HOW vectors. If the query duration and the query day parting target have conflicts, the query first may be split into multiple queries before converting into HOW vectors. A bitmap index then may be utilized to find matching impressions satisfying all targets (including hour-of-week vectors) of each split query.

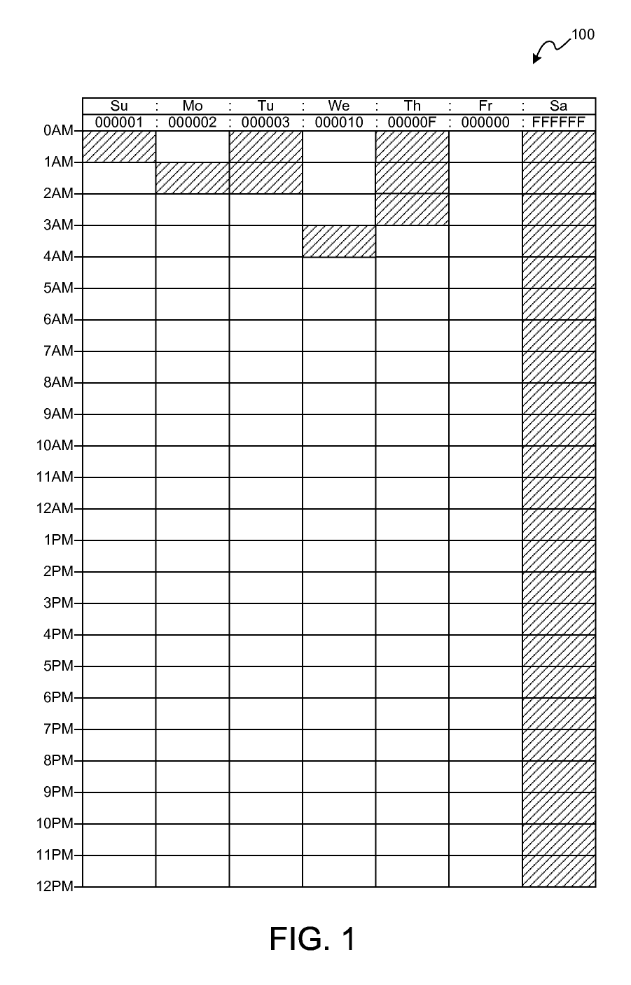

FIG. 1 illustrates a table 100 containing an example hour-of-week (HOW) bit vector. In general, each HOW vector may include an ordered arrangement having seven groups of six hexadecimal digits with each group of six digits separated by a colon (:). Using hex numbers ensures that the maximum number of characters in each HOW vector is no more than 48 characters (42 hex digits and six colons). The example HOW vector for FIG. 1 is

000001:000002:000003:000010:00000F:000000:FFFFFF (1)

Each group in a HOW vector may reflect a day of the week and be coded to target one or more hours a twenty-four hour day. For example, the group containing 000001 is positioned in the left most column of the example HOW vector and thus represents Sunday. As in FIG. 1, the digits 000001 target 0 AM-1 AM. The group containing 000002 is immediately adjacent to the first group and positioned in the second column of the example HOW vector and thus represents Monday. The digits 000002 target 1 AM-2 AM. Table I below lists the target hour ranges provided by the example, HOW vector:

TABLE I

| Sunday | Monday | Tuesday | Wednesday | Thursday | Friday | Saturday |
|---|---|---|---|---|---|---|
| 000001 | 000002 | 000003 | 000010 | 00000F | 000000 | FFFFFF |
| 0 AM-1 AM | 1 AM-2 AM | 0 AM-2 AM | 3 AM-4 AM | 0 AM-3 AM | — | 0 AM-12 PM |

General Online Advertising

The information disclosed below relates to forecasting a supply of online advertising inventory of day parting queries. In the following description, numerous details are set forth for purpose of explanation. However, one of ordinary skill in the art will realize that a skilled person may practice the methods without the use of the specific details. In other instances, the disclosure may show well-known structures and devices in block diagram form to prevent unnecessary details from obscuring the written description.

Advertisers may desire to present advertisements to viewers of webpages to promotion of some product or service. To raise money as an ongoing business, a network entity operating an advertising system may enter into advertising demand contracts whereby the network entity obligates itself to use its advertising system to deliver a number of advertisements to its advertising inventory over a given amount of time. To meet the advertising demand contracts, the network entity may acquire a supply of advertising inventory. In general, supply may the amount of advertising inventory available for a price at any given time in an advertising system. Demand may reflect the number of advertisements that the advertising system is contractually obligated to serve to the advertising inventory that is in supply. Before discussion forecasting a supply of online advertising inventory of day parting queries, it may be helpful to describe an advertising system.

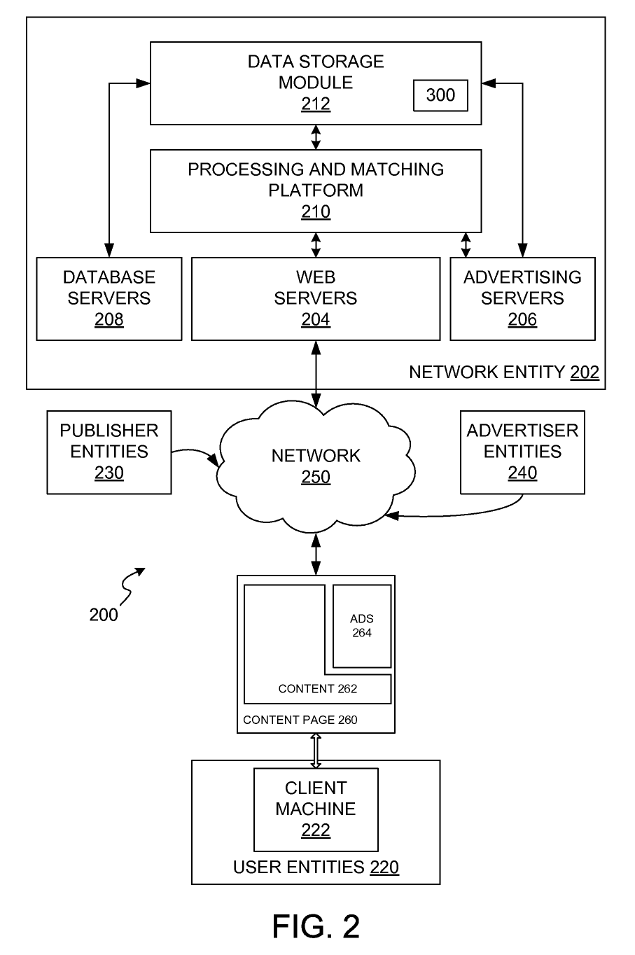

FIG. 2 is a block diagram illustrating a system 200. A request to place an advertisement on a webpage may be thought of as a page impression opportunity 202. System 200 may be a group of independent but interrelated elements that may work to acquire page impressions 202 and to place advertisements 204 on a webpage 206 in those page impressions 202 for viewing by a user 208. System 200 may place each page impression 202 into an advertising inventory 210, where advertising inventory 210 contains the supply of ad spaces available for sale by system 200 during a certain time frame.

In the examples described below, users 208 may employ a client machine 212 to access a network entity 214, such as, for example, a content service-provider, over a network 216 such as the Internet and further input various data, which system 200 subsequently may capture by selective processing modules within the network-based entity 214. User 208 input typically comprises “events.” In one example, an event may be a type of action initiated by user 214, typically through a conventional mouse click command. Events include, for example, advertisement clicks, search queries, search clicks, sponsored listing clicks, page views, and advertisement views. However, events, as used herein, may include any type of online navigational interaction or search-related events.

Each such event initiated by user 208 may trigger a transfer of content information to user 208 from network 216. User 208 may see the displayed content information typically in the form of a webpage 206 on the user's client computer 212. Webpage 206 may incorporate content 218 provided by publishers 220, where content 218 may include, for example, articles, and/or other data of interest to users displayed in a variety of formats. In addition, webpage 206 also may incorporate advertisements 204 as displayed advertisements 222 provided on behalf of various advertisers 224 over network 216 such as by an advertising agency. The advertising agency may be included within network entity 214, or in an alternative, system 200 may link network entity 214, advertisers 224, and the advertising agency, for example.

System 200 may be a structure having exemplar/network-based network entity 214 connected to user entities 208, publisher entities 220, and advertiser entities 224 through network 216. To satisfy some demand with supply, each may cooperate to deliver content page 206 having content 218 and advertisements 222 to user 208. Network entity 214 may communicate through network 216. In one example, network entity 214 may be a network content service provider, such as, for example, Yahoo!™ and its associated properties.

Network entity 214 may be a device that has a distinct, separate existence and includes an autonomous computer that performs calculations automatically. For example, network entity 214 may include front-end web processing servers 226, which may, for example, deliver content pages 206 and other markup language documents to multiple users, and/or handle search requests to network entity 214. In addition to web processing servers 226, network entity 214 may include processing servers to provide an intelligent interface to the back-end of network entity 214. For example, network entity 214 may include back-end servers such as advertising servers 228, and database servers 230.

Each server of network entity 214 may maintain and facilitate access to data storage modules 232. Data storage modules 232 may contain advertisements 204 and advertising inventory 210 configured to receive one or more ads from advertisements 204. In one example, advertising servers 228 may be coupled to data storage module 232 and may transmit and receive advertising content, such as, for example, advertisements, sponsored links, integrated links, and other types of advertising content, to/from advertiser entities 224 via network 216. Network entity 214 further may include a processing and matching platform 234 coupled to data storage module 232. Processing and matching platform 234 may enable matching of page content 218 to related advertisements in advertisements 204, such as through a semantic matching engine that supports contextual advertising. A goal of a contextual advertising may be to place advertisements 204 on webpage 206 that are related to content 218 to provide a good experience for user 208. System 200 may connect processing and matching platform 234 to web servers 226, advertising servers 228, and data storage module 232.

Advertisements 204 may be supplied to network entity 214 by advertiser entities 224 through contractual agreement. For example, a guaranteed contract may obligate network entity 214 to match advertisements from advertiser entities 224 to opportunities on a guaranteed quantity/time basis. A nonguaranteed contract may obligate network entity 214 to match advertisements from advertiser entities 224 to opportunities should certain preconditions be met. As an impression delivery promisor, network entity 214 may have a system to create an impression supply. For example, network entity 214 may create webpage content 218 that attracts users 208 to that webpage content 218. When a user 208 requests a particular webpage 206 belonging to network entity 214, the event may create an impression opportunity 202. When impression opportunity 202 is generated from a system maintained by network entity 214, then network entity 214 may be thought of as a publisher. Alternatively, network entity 214 may obtain impression opportunities from others as an advertisement agent.

In a typical days operation, user entities 208 may request billions of webpages 206, each of which may contain one or more page impression opportunities 202. These page impression opportunities 202 may be collected as supply of advertising inventory 210. This supply may be utilized to satisfy the billions of advertising demands placed on network entity 214 through advertising demand contracts.

Forecasting Strategies

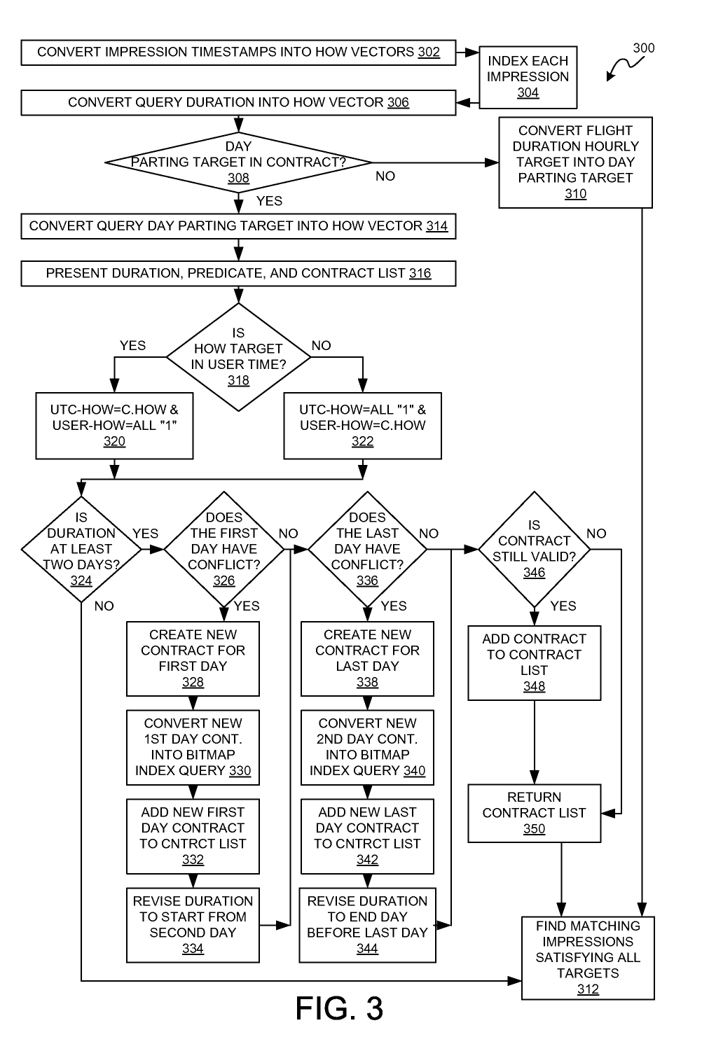

FIG. 3 is a flow diagram illustrating a method 300 implemented in a computer to forecast a supply of online advertising demand contracts having day parting targets. At processing block 302, method 300 may convert the time stamp of each impression into at least one 168-bit hour-of-week impression vector. As noted, one page impression opportunity exists when a member 220 of a webpage audience has requested to view a single webpage 260 containing an advertising space 264. A time stamp is a sequence of characters, denoting the date and/or time recorded by a computer at which user 220 requested the webpage 260 with advertising space 264, such as 2009-07-01 T 10:46 UTC. Jul. 1, 2009 was a Wednesday and network entity 202 may convert the example time stamp to include Wednesday and 10 AM to 11 AM as part of its 168-bit HOW vector.

Advertiser entity 240 may configure its day parting query based on a local time zone or based on Universal Time Coordinated (UTC), a time standard that is based on International Atomic Time (TAI) and is for many Internet and World Wide Web standards, such as the Network Time Protocol. Advertiser entity 240 may indicate user time zone or UTC time zone through a field called ‘time-zone’ in the target predicate. To account for this, network entity 202 may translate hour information of each impression in supply into corresponding HOW attributes in both user time zone and UTC time zone. In other words, method 300 may convert the time stamp of each impression into two 168-bit hour-of-week vectors. For example, if network entity 202 receives an impression on Monday 8 AM in UTC time (5 AM in the user's Buenos Aires, Argentina time zone), then the 24 hours of Sunday have passed and the time stamp may be converted into two attributes:

UTC-HOW=32 (24+8) (2),

User-HOW=29 (24+5) (3),

where values 32 and 29 correspond to the index of bits in HOW vector for supporting day parting target matching.

At processing block 304, method 300 may index all impressions, including converting each HOW vector converted into an index set. Here, day parting attributes may be indexed together with other attributes for all impressions in the supply utilizing a bitmap index. A bitmap index is a special kind of database index that uses bitmaps and an example bitmap index is the FastBit engine, an open-source bitmap index software that utilizes compression indexing methods to reduce the response time of search queries to accelerate searching operations of massive databases.

In matching a target to impressions, network entity 202 first converts an HOW vector into an index set. For example, the HOW vector in FIG. 1

000001:000002:000003:000010:00000F:000000:FFFFFF (1)

is converted as:

UTC-HOW in {1, 26, 49, 50, 76, 97, 98, 99, 100, . . . } (4).

Converting each HOW vector into an index set improves the matching between webpage timestamp and advertisement day parting attribute and makes finding matching impressions with the same day parting attributes is straightforward.

Before, during, and after network entity 202 receives impressions as part of its supply of impressions, network entity 202 engages in contractual relations with advertiser entities 240 and takes on obligations to serve advertisements over a given flight duration, which often include HOW day parting targets. The flight duration of a contract does not have to be always from midnight to midnight.

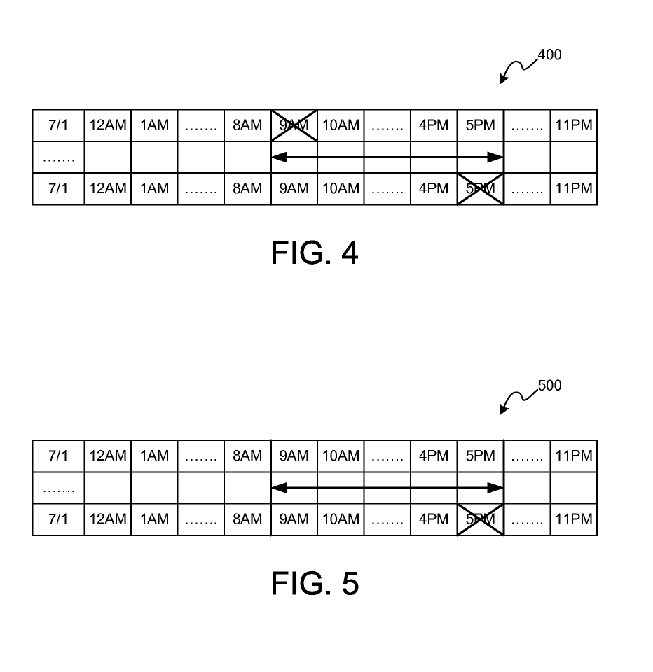

FIG. 4 illustrates an example advertising contract 400 having a Jul. 1, 2009 10 AM-Jul. 31, 2009 4 PM flight duration. Here, advertising contract 400 specifies that only hours from LOAM to midnight are valid in the first day Jul. 1, 2009 and only hours from midnight to 4 PM are valid in the last day Jul. 31, 2009. From day Jul. 2, 2009 to Jul. 30, 2009, all 24 hours are valid for each day. FIG. 5 illustrates an example advertising contract 500 having a Jul. 1, 2009 8 AM-Jul. 31, 2009 4 PM flight duration with a 9 AM-5 PM HOW day parting target.

Network entity 202 may code both the flight duration and any HOW day parting target into keyword phrases that may be entered into a search field as a query. To aid in matching this with the time stamp HOW vectors UTC-HOW and User-HOW, network entity 202 may convert each query flight duration into a HOW vector at processing block 306. In the above examples, network entity 202 may convert both the Jul. 1, 2009 10 AM-Jul. 31, 2009 4 PM flight duration of advertising contract 400 and the Jul. 1, 2009 8 AM-Jul. 31, 2009 4 PM flight duration flight duration of advertising contract 500 into their own Duration-HOW vector.

At processing block 308, method 300 may determine whether the advertising contract includes a day parting target. Both advertising contract 400 and advertising contract 500 specify a 9 AM-5 PM HOW day parting target. However, not all advertising contracts include a day parting target. If there is no day parting targeting in the advertising contract, method 300 may convert the hourly target in the flight duration into a day parting target for the first day, the last day and the remaining days at processing block 310. From processing block 310, method 300 may find all matching impressions that satisfy all day parting target at processing block 312.

If there is a day parting target, network entity 202 may enter into a routine to split and convert the advertising contract into bitmap index queries, such as FastBit queries. The queries may be configured to satisfy both flight duration and day parting constraint. To aid in matching these with the time stamp HOW vectors UTC-HOW and User-HOW, network entity 202 may convert each query day parting target into a HOW vector at processing block 314.

To provide day paring forecasting, it is important to split some targets for day parting. In the examples of FIG. 4 and FIG. 5, the HOW vector day parting targets are 9 AM-5 PM from Sunday to Saturday in UTC time. In the example of FIG. 4, the flight duration is Jul. 1, 2009 10 AM-Jul. 31, 2009 4 PM. If network entity 202 used the HOW vector to retrieve all matching samples without considering the flight duration, there may be some samples outside the Jul. 1, 2009 10 AM beginning of the flight duration. For example, there may be some samples at 9 AM matching the target on Jul. 1, 2009 because FastBit indexing does not match dates. These 9 AM samples are invalid samples for the first day Jul. 1, 2009 since the flight duration starts at LOAM on Jul. 1, 2009, not 9 AM. Similarly, there may be some 5 PM samples matching the target but not valid for the last day, flight duration end of Jul. 31, 2009 4 PM.

In the example of FIG. 5, the flight duration starts at Jul. 1, 2009 8 AM, which is two hour earlier that the example of FIG. 4. However, the UTC-HOW vector of the FIG. 5 example targets 9 AM-5 PM just as specified for example advertising contract 400 of FIG. 4. For example advertising contract 500, HOW works for the first day but does not work for the last day. In order to find exact matching sample for the first day, network entity 202 may create a new target predicate with proper day parting target for the days that have conflicts.

The following processing blocks may work to split a contract into conflict-free contracts to support day parting feature. In sum, network entity 202 may check if the HOW target is in user time or UTC time. Then, network entity 202 may split the first day, the last day and the remaining days from the original target, if necessary. New contracts then may be created based on the split targets and converted into bitmap index queries, such as FastBit queries. The input may be a contract (such as contract C) that specifies detail targeting predicate and duration of a contract and the output may be a list of split contracts (contractList)

At processing block 316, method 300 may present targeting predicate and duration of a contract C and a contract list iList. At processing block 318, method 300 may determine whether the HOW day parting target is in user time. If the HOW day parting target is in user time, then method 300 may set the UTC-HOW to the contract HOW (C.HOW) and set the User-How to all “1” at processing block 320. If the HOW day parting target is not in user time, then method 300 may set or initialize the UTC-HOW to all “1” and set the User-How to the contract HOW (C.HOW) at processing block 322.

Flight duration only raises the issue of contract split if the contract flight duration (C.duration) has two or more days. Thus, method 300 may determine at processing block 324 whether the contract flight duration is at least two days (covers a span of at least 48 hours). If the flight duration is not at least two days, then method 300 may proceed to processing block 312 to find all matching impressions that satisfy all day parting target. If the flight duration is at least two days, then method 300 may proceed to processing block 326.

At processing block 326, method 300 may determine whether the first day of the flight duration would generate a conflict in view of the HOW day parting target. In other words, is it possible for matching samples to be returned that have a time stamp that occurs before the start of the first day of the flight duration? Recall that 9 AM matching samples returned for advertising contract 400 were invalid samples for the first day Jul. 1, 2009 of that contract's flight duration since the flight duration started at 10 AM on Jul. 1, 2009, not 9 AM. To determine whether the first day of the flight duration would generate a conflict at processing block 326, method 300 may invoke method 600.

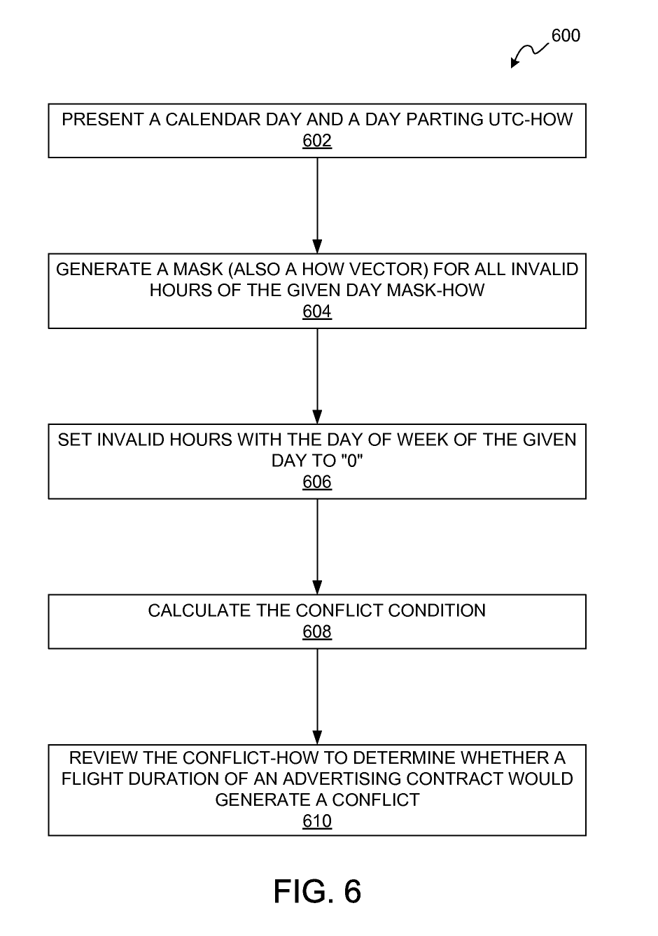

FIG. 6 is a method 600 to determine whether a flight duration of an advertising contract would generate a conflict. At processing block 602, method 600 may present a calendar day and a day parting UTC-HOW. At processing block 604, method 600 may generate a mask (also a HOW vector) for all invalid hours of the given day Mask-HOW. For example, the vector Mask-HOW may be generated by initialize an HOW vector to all “1”. At processing block 606, method 600 may set invalid hours with the day of week of the given day to “0”.

Method 600 may be based on binary operations applied to the HOW vectors. Thus, at processing block 608, method 600 may calculate the conflict condition. In an example, method 600 may calculate the conflict condition according to the equation (5):

Conflict-HOW=UTC-HOW−Mask-HOW, (5)

where the operator “−” between UTC-HOW vector and Mask-HOW vector is an binary operator that is defined as on any binary variable a and b as equation (6):

$$a - b = \{ \begin{matrix}1 & a = 1 , b = 0 \\ 0 & otherwise .\end{matrix} \qquad ( 6 )$$

At processing block 610, method 600 may review the Conflict-HOW vector to determine whether a flight duration of an advertising contract would generate a conflict. For example, if the resulting Conflict-HOW is not all “0”, then method 600 may determine at processing block 610 that there is a conflict.

An example may help bring out some details of method 600. Assume that network entity 202 is processing impression supply and advertising demand contracts on Jul. 1, 2009 10 AM-midnight and that a 9 AM-5 PM UTC-HOW day parting target vector is determine to be

UTC-HOW₁=01FE00:01FE00:01FE00:01FE00:01FE00:01FE00:01FE00 (7)

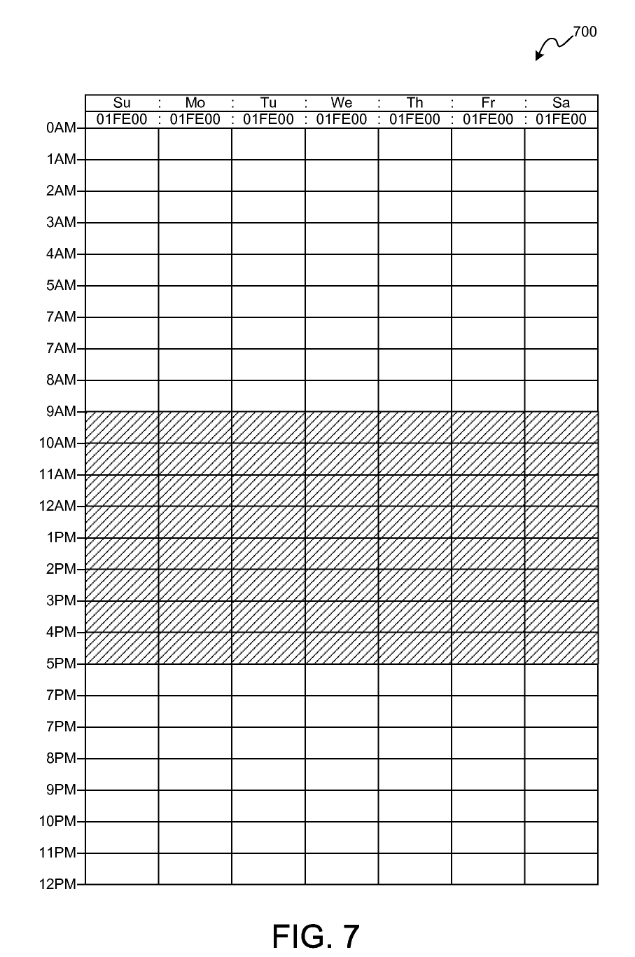

FIG. 7 illustrates a table 700 containing an example 9 AM-5 PM hour-of-week (HOW) bit vector. The calendar date of Jul. 1, 2009 is a Wednesday.

With the calendar day and a day parting UTC-HOW presented as per processing block 602, network entity 202 may generate a Mask-HOW per processing block 604. Here, network entity 202 may initialize an HOW vector to be all “1” as in

Mask-HOW₁=FFFFFF:FFFFFF:FFFFFF:FFFFFF:FFFFFF:FFFFFF:FFFFFF (8).

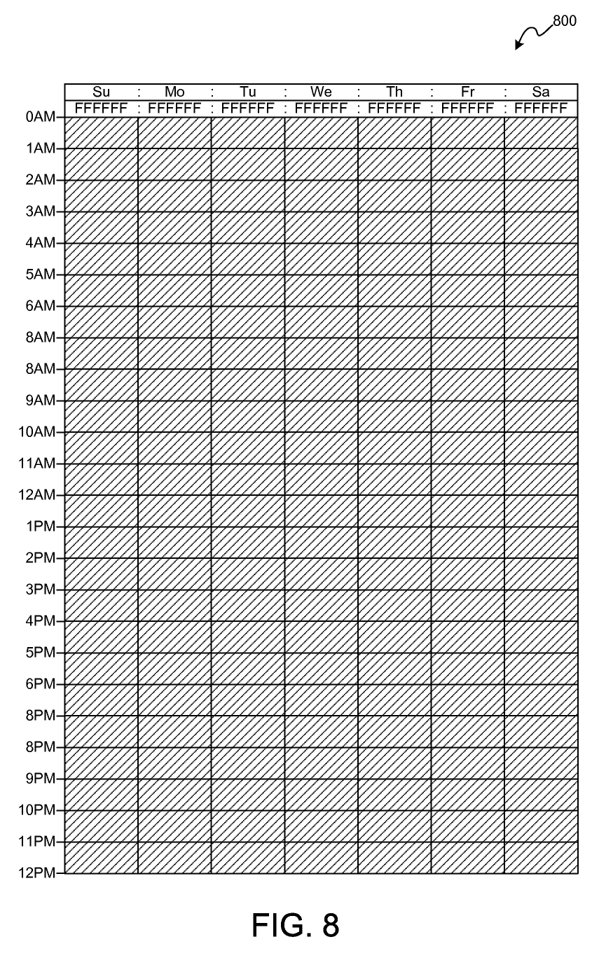

FIG. 8 illustrates a table 800 containing an example 0 AM-12 PM hour-of-week (HOW) bit vector.

With the Wednesday, Jul. 1, 2009 first day flight duration beginning at 9 AM, the hours on Jul. 1, 2009 that are before 9 AM are invalid hours. In other words, midnight to 9 AM on Wednesday are the invalid hours. Thus, network entity 202 may apply processing block 606 and set invalid hours midnight to 9 AM for the Wednesday day of week of the given day to “0”. In this example, the Mask-HOW₁ of equation (8) may be updated as:

Mask-HOW₂=FFFFFF:FFFFFF:FFFFFF:FFFC00:FFFFFF:FFFFFF:FFFFFF (9).

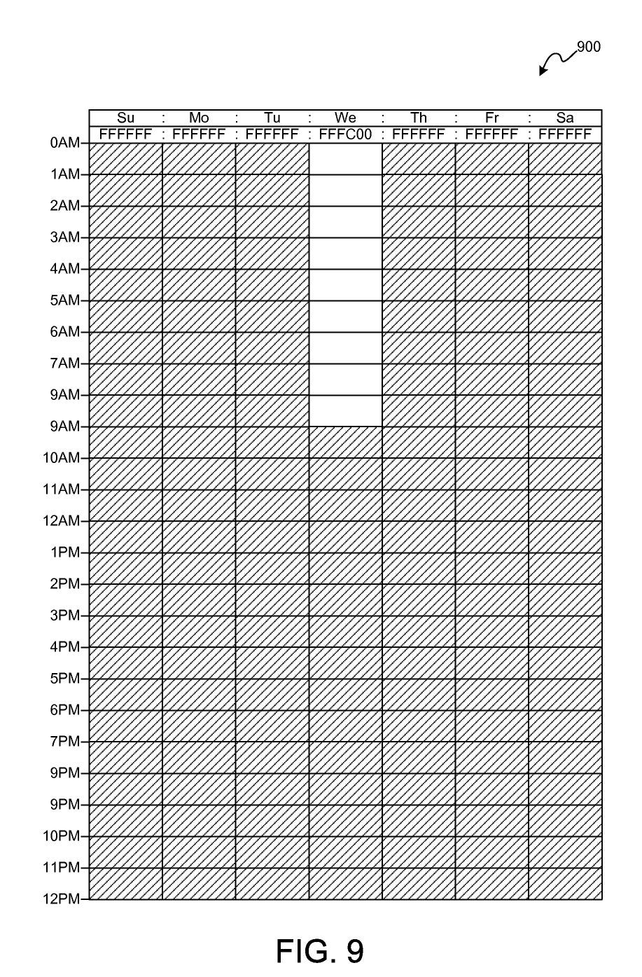

Note how the six hexadecimal digits for the Sunday, Monday, Tuesday, Thursday, Friday, and Saturday Mask-HOW groups remain unchanged and only the Wednesday Mask-HOW group is affected by the update. FIG. 9 illustrates a table 900 containing an example 0 AM-12 PM hour-of-week (HOW) bit vector for each day of the week except Wednesday, which is coded for 9 AM-12 PM HOW.

From this point, network entity 202 may apply processing block 608 to calculate the conflict condition and compute the Conflict-HOW. From the above, recall that

Conflict-HOW=UTC-HOW−Mask-HOW, (5)

UTC-HOW₁=01FE00:01FE00:01FE00:01FE00:01FE00:01FE00:01FE00 (7)

Mask-HOW₂=FFFFFF:FFFFFF:FFFFFF:FFFC00:FFFFFF:FFFFFF:FFFFFF (9).

Applying the binary operator “−” of equation (6) in equation (5), network entity 202 obtains the Conflict-HOW as:

Conflict-HOW=000000:000000:000000:000200:000000:000000:000000 (10).

Since the Conflict-HOW in (10) above is not all “0”, then network entity 202 may conclude that there is a conflict and take steps to address this conflict.

Returning to method 300 of FIG. 3, method 300 may proceed to processing block 336 if method 300 determines that the first day of the flight duration would not generate a conflict. Alternatively, method 300 may proceed to processing block 328 if method 300 determines that the first day of the flight duration would generate a conflict. At processing block 328, method 300 may generate a new first day contract for the first day of the flight duration of the conflict contract C. Creating a new contract from a conflict contract includes not only updating the flight duration but also updating the day parting UTC-HOW.

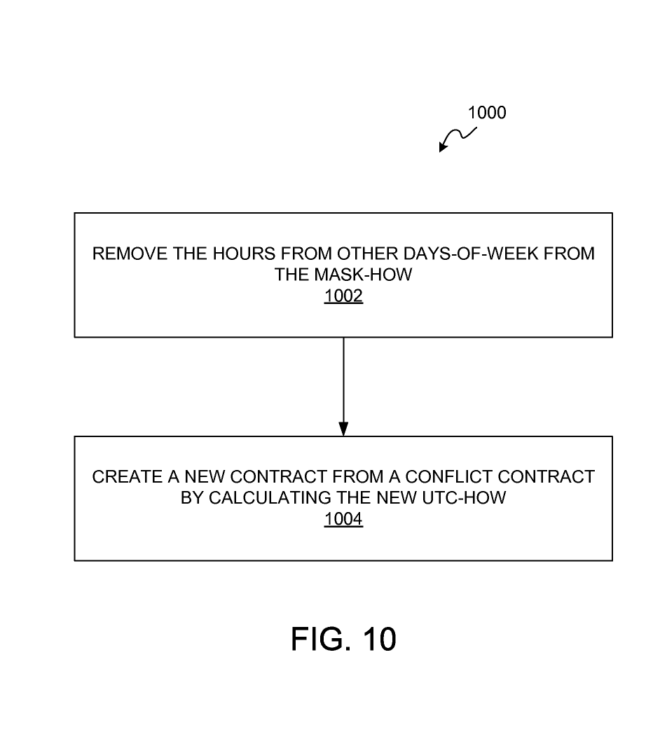

FIG. 10 is a method 1000 to create a new contract from a conflict contract. At processing block 1002, method 1000 may remove the hours from other days-of-week from the Mask-HOW. The other day-of-week may be those days that are not the first day or the last day of the flight duration. In the running example for the Wednesday, Jul. 1, 2009 first day flight duration beginning at 9 AM, the other days-of-week are Thursday through Tuesday. Recall,

Mask-HOW₂=FFFFFF:FFFFFF:FFFFFF:FFFC00:FFFFFF:FFFFFF:FFFFFF (9).

Removing the hours from other days-of-week from the Mask-HOW₂ results in a Mask-HOW₃ of:

Mask-HOW₃=000000:000000:000000:FFFC00:000000:000000:000000 (11).

At processing block 1004, method 1000 may create a new contract from a conflict contract by calculating the new UTC-HOW₂ according to equation (12):

UTC-HOW₂=UTC-HOW₁ & Mask-HOW₃ (12)

In the running example with

UTC-HOW₁=01FE00:01FE00:01FE00:01FE00:01FE00:01FE00:01FE00 (7),

the new/updated UTC-HOW₂ may be calculated as:

UTC-HOW₂=000000:000000:000000:01FC00:000000:000000:000000 (13),

With the new first day contract created, network entity 202 may return to method 300 of FIG. 3 and convert the new first day contract into a bitmap index query at processing block 330. At processing block 332, method 300 may add the new contract for the first day into the contract list (iList). At processing block 334, method 300 may revise/update the original flight duration (C.duraction) to start from the second day. In the running example, method 300 may revise the original Jul. 1, 2009 9 AM flight duration to start at Jul. 2, 2009 0 AM, the second day of original Jul. 1, 2009 9 AM-Jul. 31, 2009 4 PM flight duration. By starting the flight duration at 0 AM on Jul. 2, 2009, all matched samples located on Jul. 2, 2009 will be valid samples for the revised first day of the original contract so that the revised flight duration first day no longer provides conflict. From processing block 334, method 300 may proceed to processing block 336.

At processing block 336, method 300 may determine whether the last day of the flight duration would generate a conflict in view of the HOW day parting target. In other words, is it possible for matching samples to be returned that have a time stamp that occurs after the end of the last day of the flight duration? To determine whether the last day of the flight duration would generate a conflict at processing block 336, method 300 may invoke method 600.

Method 300 may proceed to processing block 346 if method 300 determines that the last day of the flight duration would not generate a conflict. Alternatively, method 300 may proceed to processing block 338 if method 300 determines that the last day of the flight duration would generate a conflict. At processing block 338, method 300 may create a new last day contract for the last day from the conflict contract C. Method 300 may invoke method 1000 to create a new last day contract for the last day from the conflict contract C. At processing block 342, method 300 may add the new contract for the last day into the contract list (iList). At processing block 344, method 300 may revise/update the original flight duration (C.duraction) to end before the last day. In the running example, method 300 may revise the original Jul. 31, 2009 4 PM flight duration ending time to end at Jul. 30, 2009 12 PM, the day just prior to the end of the original Jul. 1, 2009 9 AM-Jul. 31, 2009 4 PM flight duration. By ending the flight duration at 12 PM (midnight) on Jul. 30, 2009, all matched samples located on Jul. 30, 2009 will be valid samples for the revised last day of the original contract so that the revised flight duration last day no longer provides conflict. From processing block 344, method 300 may proceed to processing block 346.

Ad processing block 346, method 300 may determine whether the original contract is a valid contract. In the running example, method 300 may determine whether contract C is a valid contract. If the original contract is not a valid contract, method 300 may proceed to processing block 350. If the original contract is a valid contract, method 300 may add the original contract into the contract list (iList) at processing block 348. Method 300 may proceed to processing block 350 from processing block 348.

At processing block 350, method 300 may return the contract list (iList). If either the first day or last day of the original flight duration caused a conflict, then the contract list (iList) originally presented at processing block 316 will have been updated. Method 300 may proceed to processing block 312 from processing block 350.

At processing block 312, method 300 may find all matching impressions that satisfy all day parting targets. For example, method 300 may call a FastBit function to find matching impressions satisfying all targets (including hour-of-week vectors) of each split query.

Implementing method 300 in a system such as online advertising system 200 to forecast a supply of advertising demand contracts having day parting targets provides certain advantages. For example, the day parting representation is simplified by the hour-of-week (HOW) vector. The HOW day parting vector turns day parting target matching and processing into regular bit operations, which have been well optimized in the past decades. The disclosed technique is scalable to very large data (in terms of impressions and queries) through bitmap index software such as provided by FastBit technology. In addition, the disclosed technique is an efficient way to detect and solve conflicts in the hour-of-week vectors. The method only consists of regular bit operations, which can be performed efficiently by existing bit operation hardware or software library.

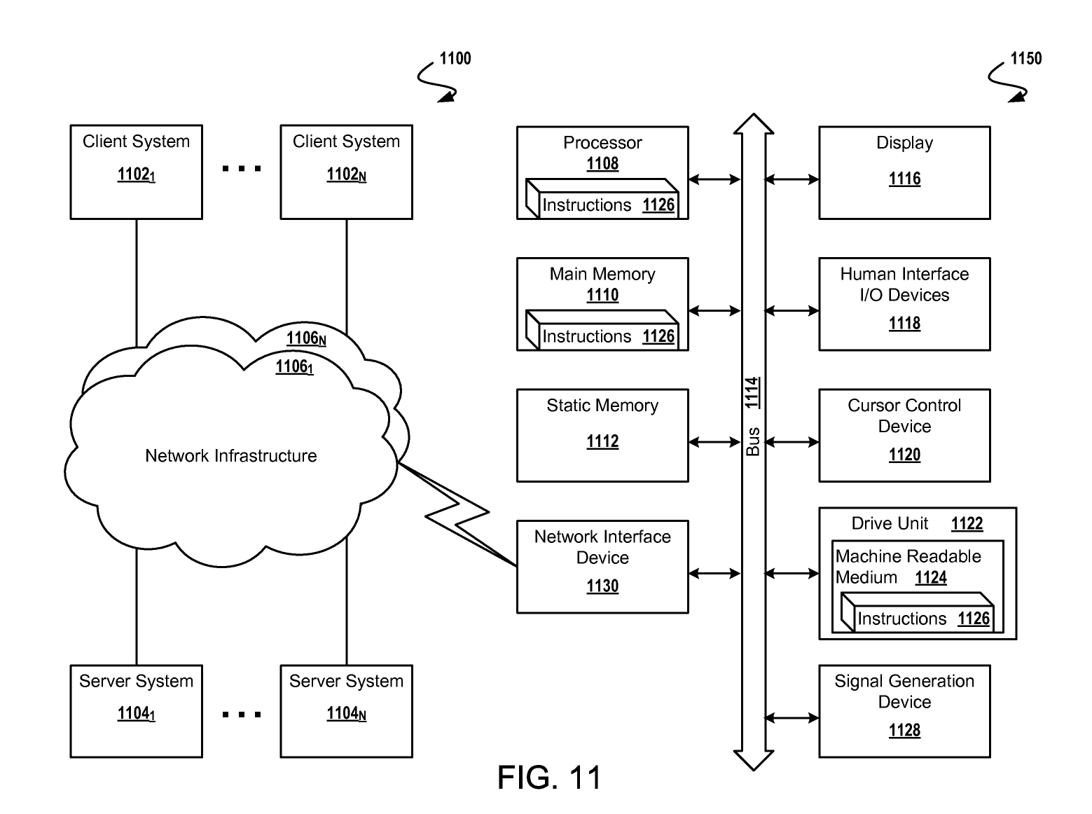

FIG. 11 is a diagrammatic representation of a network 1100. Network 100 may include nodes for client computer systems 1102₁ through 1102_{N}, nodes for server computer systems 1104₁ through 1104_{N}, and nodes for network infrastructure 1106₁ through 1106_{N}. Any of these notes or combination thereof may comprise a machine 1150 within which a set of instructions for causing the machine to perform any one of the techniques discussed above may be executed. The embodiment shown is purely exemplary, and might be implemented in the context of one or more of the figures herein.

Any node of the network 1100 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A system also may implement a processor as a combination of computing devices (e.g., a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g., a client computer system, a server computer system) and/or may comprise one or more embedded computer systems, a massively parallel computer system, and/or a cloud computer system.

The computer system 1150 includes a processor 1108 (e.g., a processor core, a microprocessor, a computing device, etc), a main memory 1110 and a static memory 1112, which communicate with each other via a bus 1114. The machine 1150 may further include a display unit 1116 that may comprise a touch-screen, or a liquid crystal display (LCD), or a light emitting diode (LED) display, or a cathode ray tube (CRT). As shown, the computer system 1150 also includes a human input/output (I/O) device 1118 (e.g., a keyboard, an alphanumeric keypad, etc), a pointing device 1120 (e.g., a mouse, a touch screen, etc), a drive unit 1122 (e.g., a disk drive unit, a CD/DVD drive, a tangible computer readable removable media drive, an SSD storage device, etc), a signal generation device 1128 (e.g., a speaker, an audio output, etc), and a network interface device 1130 (e.g., an Ethernet interface, a wired network interface, a wireless network interface, a propagated signal interface, etc).

The drive unit 1122 includes a machine-readable medium 1124 on which is stored a set of instructions (i.e., software, firmware, middleware, etc) 1126 embodying any one, or all, of the methodologies described above. The set of instructions 1126 also may reside, completely or at least partially, within the main memory 1110 and/or within the processor 1108. The network bus 1114 of the network interface device 1130 may provide a way to further transmit or receive the set of instructions 1126.

A computer may include a machine to perform calculations automatically. A computer may include a machine that manipulates data according to a set of instructions. In addition, a computer may include a programmable device that performs mathematical calculations and logical operations, especially one that can process, store and retrieve large amounts of data very quickly.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; electrical, optical, acoustical, or any other type of media suitable for storing information.

A computer program product on a storage medium having instructions stored thereon/in may implement part or all of system 200. The system may use these instructions to control, or cause, a computer to perform any of the processes. The storage medium may include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Storing may involve putting or retaining data in a memory unit such as a storage medium. Retrieving may involve locating and reading data from storage. Delivering may involve carrying and turning over to the intended recipient. For example, information may be stored by putting data representing the information in a memory unit, for example. The system may store information by retaining data representing the information in a memory unit, for example. The system may retrieve the information and deliver the information downstream for processing. The system may retrieve a message such as an advertisement from an advertising exchange system, carried over a network, and turned over to a member of a target-group of members.

Stored on any one of the computer readable medium, system 200 may include software both to control the hardware of a general purpose/specialized computer or microprocessor and to enable the computer or microprocessor to interact with a human consumer or other mechanism utilizing the results of system 200. Such software may include without limitation device drivers, operating systems, and user applications. Ultimately, such computer readable medium further may include software to perform system 200.

Although the system may utilize the techniques in the online advertising context, the techniques also may be applicable in any number of different open exchanges where the open exchange offers products, commodities, or services for purchase or sale. Further, many of the features described herein may help data buyers and others to target users in audience segments more effectively. However, while data in the form of segment identifiers may be generally stored and/or retrieved, examples of the invention preferably do not require any specific personal identifier information (e.g., name or social security number) to operate.

The techniques described herein may be implemented in digital electronic circuitry, or in computer hardware, firmware, software recorded on a computer-readable medium, or in combinations of them. The system may implement the techniques as a computer program product, i.e., a computer program tangibly embodied in an information carrier, including a machine-readable storage device, for execution by, or to control the operation of, data processing apparatus, e.g., a programmable processor, a computer, or multiple computers. Any form of programming language may convey a written computer program, including compiled or interpreted languages. A system may deploy the computer program in any form, including as a stand-alone program or as a module, component, subroutine, or other unit recorded on a computer-readable medium and otherwise suitable for use in a computing environment. A system may deploy a computer program for execution on one computer or on multiple computers at one site or distributed across multiple sites and interconnected by a communication network.

A system may perform the methods described herein in programmable processors executing a computer program to perform functions disclosed herein by operating on input data and generating output. A system also may perform the methods by special purpose logic circuitry and implement apparatus as special purpose logic circuitry special purpose logic circuitry, e.g., an FPGA (field programmable gate array) or an ASIC (application-specific integrated circuit). Modules may refer to portions of the computer program and/or the processor/special circuitry that implements that functionality. An engine may be a continuation-based construct that may provide timed preemption through a clock that may measure real time or time simulated through language like scheme. Engines may refer to portions of the computer program and/or the processor/special circuitry that implements the functionality. A system may record modules, engines, and other purported software elements on a computer-readable medium. For example, a processing engine, a storing engine, a retrieving engine, and a delivering engine each may implement the functionality of its name and may be recorded on a computer-readable medium.

Processors suitable for the execution of a computer program include, by way of example, both general and special purpose microprocessors, and any processors of any kind of digital computer. Generally, a processor may receive instructions and data from a read-only memory or a random access memory or both. Essential elements of a computer may be a processor for executing instructions and memory devices for storing instructions and data. Generally, a computer also includes, or may be operatively coupled to receive data from or transfer data to, or both, mass storage devices for storing data, e.g., magnetic, magneto-optical disks, or optical disks. Information carriers suitable for embodying computer program instructions and data include all forms of non-volatile memory, including by way of example semiconductor memory-devices, e.g., EPROM, EEPROM, and flash memory devices; magnetic disks, e.g., internal hard disks or removable disks; magneto-optical disks; and CD-ROM and DVD-ROM disks. A system may supplement a processor and the memory by special purpose logic circuitry and may incorporate the processor and the memory in special purpose logic circuitry.

To provide for interaction with a user, a skilled person may implement the techniques described herein on a computer. The computer may have a display device, e.g., a CRT (cathode ray tube) or LCD (liquid crystal display) monitor, to display information to the user and a keyboard and a pointing device, e.g., a mouse or a trackball. The user may provide input via these devices to the computer (e.g., interact with a user interface element, for example, by clicking a button on such a pointing device). Other kinds of devices may be used to provide for interaction with a user as well; for example, feedback provided to the user includes any form of sensory feedback, e.g., visual feedback, auditory feedback, or tactile feedback; and input from the user may be received in any form, including acoustic, speech, or tactile input.

The techniques described herein may be implemented in a distributed computing system that includes a back-end component, e.g., as a data server, and/or a middleware component, e.g., an application server, and/or a front-end component, e.g., a client computer having a graphical user interface and/or a Web browser through which a user interacts with an implementation of the invention, or any combination of such back-end, middleware, or front-end components. A system may interconnect the components of the system by any form or medium of digital data communication, e.g., a communication network. Examples of communication networks include a local area network (“LAN”) and a wide area network (“WAN”), e.g., the Internet, and include both wired and wireless networks.

The computing system may include clients and servers. A client and server may be generally remote from each other and typically interact over a communication network. The relationship of client and server arises by virtue of computer programs running on the respective computers and having a client-server relationship to each other. One of ordinary skill recognizes any or all of the foregoing implemented and described as computer readable media.

In the above description, numerous details have been set forth for purpose of explanation. However, one of ordinary skill in the art will realize that a skilled person may practice the invention without the use of these specific details. In other instances, the disclosure may present well-known structures and devices in block diagram form to avoid obscuring the description with unnecessary detail. In other words, the details provide the information disclosed herein merely to illustrate principles. A skilled person should not construe this as limiting the scope of the subject matter of the terms of the claims. On the other hand, a skilled person should not read the claims so broadly as to include statutory and nonstatutory subject matter since such a construction is not reasonable. Here, it would be unreasonable for a skilled person to give a scope to the claim that is so broad that it makes the claim non-statutory. Accordingly, a skilled person is to regard the written specification and figures in an illustrative rather than a restrictive sense. Any limitations claimed are disclosed for each embodiment in the description. Moreover, a skilled person may apply the principles disclosed to achieve the advantages described herein and to achieve other advantages or to satisfy other objectives, as well.

What is claimed is:

1. A method implemented in a computer to forecast a supply of online advertising demand contracts having day parting targets, the method comprising:
receiving, at a computer, impressions having times stamps and an online advertising demand contract having a flight duration and a day parting target;
processing, in the computer, the impressions and the day parting target by:
converting the time stamp of each impression into an hour-of-week impression vector;
converting the day parting target into an hour-of-week day parting target vector; and
comparing the hour-of-week day parting target vector to each hour-of-week impression vector to output a set of impressions that meet both the flight duration and day parting target of the online advertising demand contract.

2. The method of claim 1, where the hour-of-week day parting target vector includes 168 bits, where each bit in the hour-of-week vector corresponds to a particular hour in a 168 hour week.

3. The method of claim 1, where the flight duration includes a first day, the method further comprising:
determining whether the first day of the flight duration would generate a conflict in view of the hour-of-week day parting target vector; and
generating a new first day contract for the first day of the flight duration if the first day of the flight duration would generate a conflict in view of the hour-of-week day parting target vector.

4. The method of claim 3, where determining whether the first day of the flight duration would generate a conflict in view of the hour-of-week day parting target vector includes generating a generating a mask hour-of-week vector.

5. The method of claim 3, where determining whether the first day of the flight duration would generate a conflict in view of the hour-of-week day parting target vector includes applying a binary operator to generate a conflict-hour-of-week vector.

6. The method of claim 1, further comprising:
receiving, at a computer, a time stamp of for an impression; and
processing, in the computer, the time stamp by:
converting the time stamp into an hour-of-week impression vector.

7. The method of claim 1, further comprising:
determining whether the day parting target is in user time.

8. The method of claim 1, where the flight duration includes a last day, the method further comprising:
determining whether the last day of the flight duration would generate a conflict in view of the hour-of-week day parting target vector; and
generating a new last day contract for the last day of the flight duration if the last day of the flight duration would generate a conflict in view of the hour-of-week day parting target vector.

9. The method of claim 8, where determining whether the last day of the flight duration would generate a conflict in view of the hour-of-week day parting target vector includes at least one of generating a generating a mask hour-of-week vector and applying a binary operator to generate a conflict-hour-of-week vector.

10. A computer readable medium containing executable instructions stored thereon, which, when executed in a computer, cause the computer to forecast a supply of online advertising demand contracts having day parting targets, the instructions for:
receiving, at a computer, an online advertising demand contract having a flight duration and a day parting target; and
processing, in the computer, the day parting target by:
converting the day parting target into an hour-of-week day parting target vector.

11. The computer readable medium of claim 10, where the hour-of-week day parting target vector includes 168 bits, where each bit in the hour-of-week vector corresponds to a particular hour in a 168 hour week.

12. The computer readable medium of claim 10, where the flight duration includes a first day, the instructions further for:
determining whether the first day of the flight duration would generate a conflict in view of the hour-of-week day parting target vector; and
generating a new first day contract for the first day of the flight duration if the first day of the flight duration would generate a conflict in view of the hour-of-week day parting target vector.

13. The computer readable medium of claim 12, where determining whether the first day of the flight duration would generate a conflict in view of the hour-of-week day parting target vector includes generating a generating a mask hour-of-week vector.

14. The computer readable medium of claim 12, where determining whether the first day of the flight duration would generate a conflict in view of the hour-of-week day parting target vector includes applying a binary operator to generate a conflict-hour-of-week vector.

15. The computer readable medium of claim 10, the instructions further for:
receiving a time stamp of for an impression; and
processing the time stamp by:
converting the time stamp into an hour-of-week impression vector.

16. The computer readable medium of claim 10, the instructions further for:
determining whether the day parting target is in user time.

17. The method of claim 8, where the flight duration includes a last day, the method further comprising:
determining whether the last day of the flight duration would generate a conflict in view of the hour-of-week day parting target vector; and
generating a new last day contract for the last day of the flight duration if the last day of the flight duration would generate a conflict in view of the hour-of-week day parting target vector.

18. The method of claim 17, where determining whether the last day of the flight duration would generate a conflict in view of the hour-of-week day parting target vector includes at least one of generating a generating a mask hour-of-week vector and applying a binary operator to generate a conflict-hour-of-week vector.

19. A system to forecast a supply of online advertising demand contracts having day parting targets, the system comprising:
at least one web server, comprising at least one processor and memory, to receive an online advertising demand contract having a flight duration and a day parting target; and
a processing and matching platform, comprising at least one processor and memory, coupled to the web server to process the day parting target by converting the day parting target into an hour-of-week day parting target vector.

20. The system of claim 19, where the hour-of-week day parting target vector includes 168 bits, where each bit in the hour-of-week vector corresponds to a particular hour in a 168 hour week.

21. The system of claim 19, where the flight duration includes a first day and the at least one processor and memory further to determine whether the first day of the flight duration would generate a conflict in view of the hour-of-week day parting target vector and to generate a new first day contract for the first day of the flight duration if the first day of the flight duration would generate a conflict in view of the hour-of-week day parting target vector.

22. The system of claim 21, where determining whether the first day of the flight duration would generate a conflict in view of the hour-of-week day parting target vector includes generating a generating a mask hour-of-week vector.

23. The system of claim 21, where determining whether the first day of the flight duration would generate a conflict in view of the hour-of-week day parting target vector includes applying a binary operator to generate a conflict-hour-of-week vector.

24. The system of claim 19, the at least one processor and memory further to determine receive a time stamp of for an impression and to process the time stamp by converting the time stamp into an hour-of-week impression vector.

25. The system of claim 19, the at least one processor and memory further to determine whether the day parting target is in user time.
